(19) United States
(12) Patent Application Publication
(10) Pub. No.: US 2005/0159202 A1
(43) Pub. Date: Jul. 21, 2005

(54) Assymetric dice game

(76) Inventors: Brian F. Colin, Homewood, IL (US); Jeffry Nauman, Yorkville, IL (US)

Correspondence Address: Welsh & Katz, Ltd.;Jon P. Christensen, 22nd Floor, 120 South Riverside Plaza, Chicago, IL, 60606, US

(21) Appl. No.: 11/054,308

(22) Filed: Feb. 9, 2005

Related U.S. Application Data
(63) Continuation of application No. 10/233,985, filed on Sep. 3, 2002.
(60) Provisional application No. 60/337,568, filed on Dec. 5, 2001.
(60) Provisional application No. 60/352,340, filed on Jan. 28, 2002.

(51) Int. Cl. G06F 17/00

(52) U.S. Cl. 463/16

(57) ABSTRACT

A method and apparatus are provided for playing a video game of chance by a player using an asymmetrical die. The method includes the steps randomly determining a side on which the asymmetrical die will land based upon a predetermined landing odds for each side of the asymmetrical die in response to a request to roll the asymmetrical die, displaying an image of the asymmetrical die lying on the randomly determined side and determining a payout to the player based upon a predetermined payout factor for the randomly determined side.

### FIELD OF THE INVENTION

The field of the invention relates to games of chance and, more particularly, to dice games.

### BACKGROUND OF THE INVENTION

Dice games are generally known. Typically, dice games are played with a pair of die. Each die is provided in the form of a cube with one to six dots disposed on each surface.

Players typically throw the dice into an enclosed area. A roll is deemed complete when the dice stop moving and come to rest. Winning and losing is typically determined by the number of dots on a top surface of the dice after the roll is complete.

By design, the size, shape and relative position of each of the “faces” on a normal die is identical to every other face on the die. The only difference among the faces is the number of dots.

This ensures that, when rolled, every face has a statistically equal chance of landing “face up”. As a consequence, any given number on a six-sided die has a one in six chance of landing “face up”.

As a consequence, the types of possible wagers on a single roll of a “normal” dice are somewhat limited.

The limited number of wagers on a single roll is why casino games such as “craps” have evolved, that use multiple rolls of the dice.

Video gaming devices traditionally avoid games involving dice rolls because dice games usually involve multiple rolls in order to offer the player a variety of wagering options. This can be time consuming. Multiple rolls lengthen the overall time it takes for a bet to be resolved. The overall time to resolve a bet in a dice game is viewed as a serious problem in an industry where every second counts. Accordingly, a need exists for a video dice game that is easy to understand and relatively fast to play.

### SUMMARY

A method and apparatus are provided for playing a video game of chance by a player using an asymmetrical die. The method includes the steps randomly determining a side on which the asymmetrical die will land based upon a predetermined landing odds for each side of the asymmetrical die in response to a request to roll the asymmetrical die, displaying an image of the asymmetrical die lying on the randomly determined side and determining a payout to the player based upon a predetermined payout factor for the randomly determined side.

### BRIEF DESCRIPTION OF THE DRAWINGS

FIG. 1 depicts a video dice game in accordance with an illustrated embodiment of the invention;

FIGS. 2-8 depict asymmetric die that may be used with the game of FIG. 1; and

FIG. 9 depicts the video dice game of FIG. 1 under a particular illustrated embodiment.

### DETAILED DESCRIPTION OF AN ILLUSTRATED EMBODIMENT

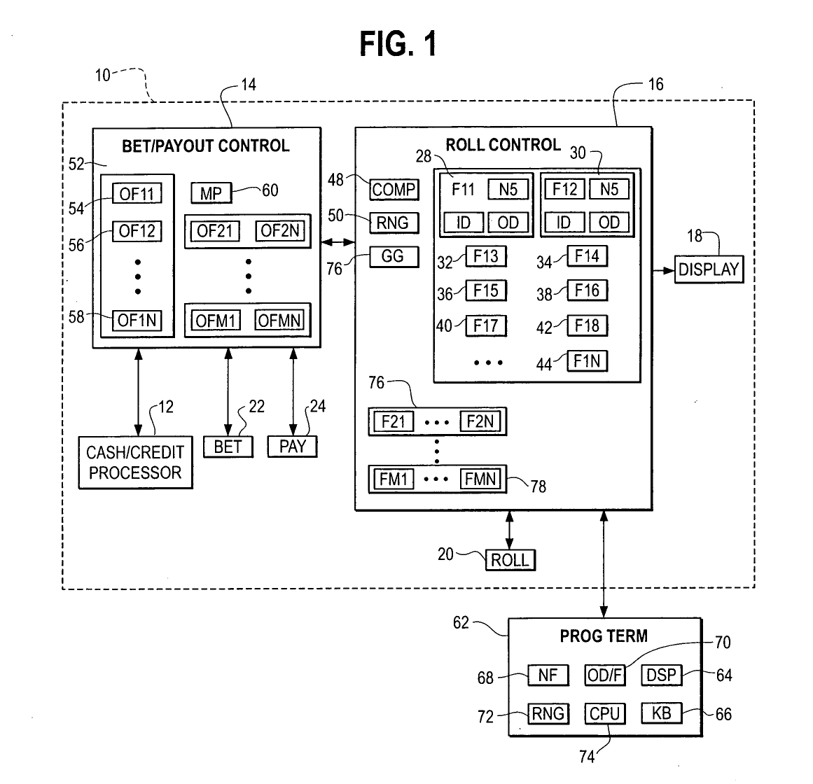

FIG. 1 is a block diagram of video dice game 10 shown generally under an illustrated embodiment of the invention. Included within the video game 10 may be a bet/payout control 14 and a roll control 16. The roll control 16 may function to accept a roll command from a control device (e.g., a pushbutton) 20 and to display a roll result in a display 18. A graphics generator 76 may provide an image of the dice as they roll across a regular or irregular surface.

The bet/payout control 14 may function to accept a bet from a player (not shown) through a cash/credit processor 12 and to provide a payout based upon the bet and results of the dice roll. Once the bet/payout control 14 receives a bet, it waits for a roll result from the roll control 16. Once it receives a roll result, the bet/payout control 14 retrieves a payout multiplier for that roll result and calculates a payout by multiplying the bet times the multiplier. The player may request a payout by activating a payout device (e.g., a pushbutton) 24 or continue to bet his winnings by activating a betting device (e.g., a pushbutton) 22.

The cash/credit processor 12 may be a conventional interface that accepts conventional forms of payment (e.g., cash, tokens, credit cards, etc.). A coin/token counter and/or bill reader may be provided for accepting bets in a tangible form. A mechanical dispenser may be included within the processor 12 to dispense payment in a tangible form (e.g., tokens). A credit card reader, card processor, modem and telephone connection may be provided within the cash/credit processor 12 to accept payment from a credit account (e.g., using a credit card) or to credit winnings to the proper credit account.

Turning now to the video game itself, an explanation will be provided regarding the die that provides the subject matter of the game to be played on the video game 10. Following a description of the die, an explanation will be provided of the apparatus and methods that may be used to determine the odds and payouts associated with the use of the die.

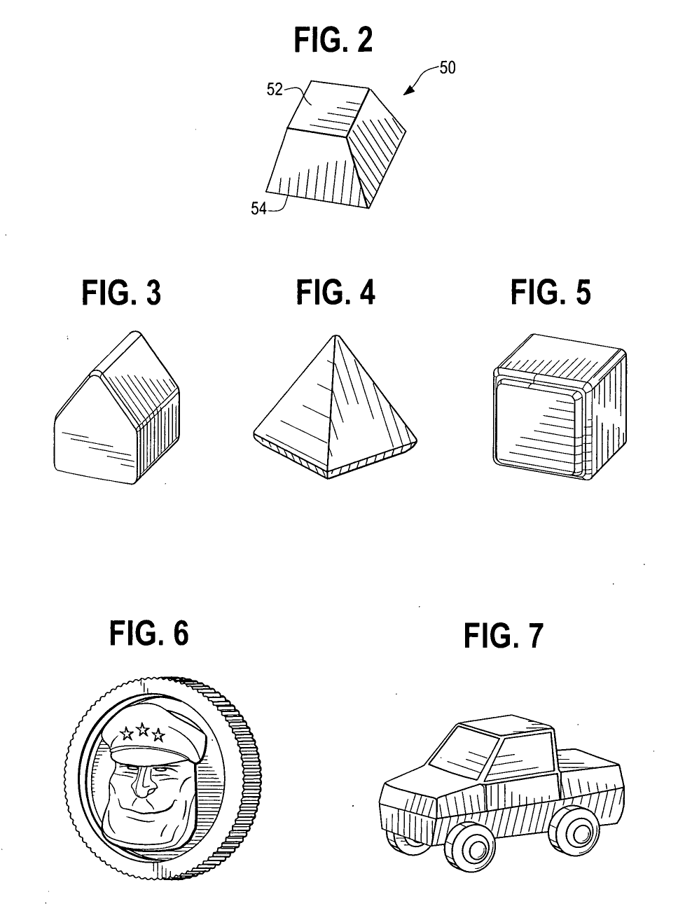

For gaming purposes, a die that has faces and angles of varying sizes would allow each different face to have a different landing odds ratio (i.e., a different statistical chance of landing “face up” and, alternatively, “face down”). FIG. 2 provides an example of such a die 50. In this situation (FIG. 2), the odds of the small face 52 landing “face up” may be far greater than any other face (e.g., 54) landing “face up”.

It should be noted that the actual percentages, or odds, associated with each of the “faces” of the object that is used to represent a die in a video game 10 are completely independent of the structure used to represent the die. Therefore, any percentage or odds may be assigned to each face of the die by the maker of the game 10 as approved by Gaming regulatory officials.

Under a first illustrated embodiment, a preliminary assignment of odds for each die face may be based upon a ratio of the surface area of the die face to the total surface area of the die. The preliminary assignment of odds may be adjusted based upon actual experience with the die or adjusted based upon some wagering algorithm.

In simpler terms, the object used to represent the die is not tied to any preconceptions of “reality”. For example, FIGS. 3-7 also represent other forms of die that may be used with the game 10. Because of the diversity of structure offered by the asymmetric die shown in FIGS. 2-7, the types of possible wagers on a single roll of the asymmetric die of FIGS. 2-7 are virtually unlimited as compared to conventional dice.

It should be noted that the method used herein in conjunction with the asymmetric die permits a wide variety of dice games that traditionally could not compete with the speed of other coin-operated betting products. These dice games may be played as fast or faster than other coin-operated betting products without sacrificing sophisticated betting options.

Though the visual video representation of a particular asymmetric object (i.e., the die) will usually be suggestive of the actual game odds, it need not necessarily be the case. Since the game CPU 16, not the video representation, is solely responsible for the actual outcome. (For example, the game CPU could be programmed to allow a die shaped like a house to land “balanced” on a corner of it's roof one time in ten thousand rolls, though visually such an outcome would appear to be impossible.

Moreover, because the odds are not necessarily tied to the visual video representation of the object, a wide variety of objects can be used as dice. Objects could be used, in fact, that would be impossible in reality (e.g., a snowflake, a raced car, a flaming meteor, a circuit clown, etc.).

To state the premise in another way, ordinary dice games have limited odds due to their physical symmetry, as well as limited outcomes due to the laws of physics. Video gaming with asymmetrical dice virtually eliminates such constraints.

It is possible for a manufacturer to offer virtually any number/range of awards, because the shape (number and relative size of the faces) of any particular asymmetrical object (die) is determined by the range and relative size of the award(s) that the manufacturer desires to offer.

As used herein, sophisticated refers to the ability of a player to place a wide variety of bets under a variety of wagering options in a single round of game play where each bet has its own odds/awards associated with it in a manner that is similar to so-called “table games” such as roulette or craps. By way of contrast, a typical video reel slot machine does not allow the player to “pick and choose” individual bets because the slot player's bet is applied universally to the outcome of the final reel position.

As noted above, the actual percentages, or odds, associated with each of the faces of the objects shown in FIGS. 2-7 that represent the die are completely independent of the means of representation. Therefore, the percentage or odds of landing upon any face may be assigned any percentage or odds desired.

For example, the “truck-shaped die” of FIG. 7 is simply a graphic representation of a video dice roll with eight possible outcomes. Therefore, any number of percentages (odds) would be possible depending on the type and number of betting options desired. Two options are presented in Table I. Note that the odds for Option 2 on the right would allow for a greater of possible bets on a single roll. It should also be noted that in evaluating the odds (and in determining a winning bet), the side that lands down is used as the criteria under the illustrated example of Table I.

TABLE I

| TRUCK POSITION | | |
|---|---|---|
| UPON LANDING | Option 1 | Option 2 |
| ON | 35% | 38% |
| WHEELS | | |
| LEFT | 15% | 14% |
| SIDE DOWN | | |
| RIGHT | 15% | 14% |
| SIDE DOWN | | |
| HOOD | 10% | 11% |
| DOWN | | |
| TRUNK | 10% | 9% |
| DOWN | | |
| ON | 5% | 7% |
| HEADLIGHTS | | |
| ON | 5% | 3% |
| TAIL-LIGHTS | | |
| ON | 5% | 4% |
| ROOF | | |

It may also be noted at this point that a distinction may be made between the odds of landing in a particular position and a payout ratio. The odds of landing in a particular position suggest a statistical probability of landing in a particular position that (in reality) may be changed by the owner of the system 10 by any adjustment factor at will. It should also be noted that the total of the probabilities for Options 1 and 2 add up to 100% in both cases. If the owner should pay out based purely on the probability then he would not make any profit.

For example, in the case of Option #1 of Table I, the odds of the trunk landing with the hood down is 10%. This suggests that the truck has a one in ten chance of landing on its hood. A one in ten chance of landing on the hood would suggest an odds multiplier of ten. However, if the owner should pay out at a rate equal to ten times the bet for each time that the truck landed on its hood, then the owner would not have any profit to pay his own expenses.

As a consequence, the game 10 may also include a payout ratio for each die position. The payout ratio may be a fixed percentage (e.g., 95%) or may use a different payout ratio for each die position.

To calculate a payout to a user, the game 10 may multiply the odds multiplier by the payout ratio. In the example above, if the odds of the truck landing on its hood is 10%, then the odds multiplier would be ten. If the odds multiplier of ten is multiplied by the payout ratio of 95%, then the final payout factor to the user may be 9.5 times the user's bet. The multiplication of the odds multiplier by a payout ratio ensures a fair return for the owner of the game 10 that may be adjusted to meet the owner's needs.

Turning now to the specifics of the system 10, the odds associated with each position of the die may be encoded as a number set (NS) saved in a set of odds selection files F11-F1N 28, 30, 32, 36, 38, 40, 42 in a memory 26 along with an image of the die in that landing position. Taking the example of Option #2 of Table I, the odds of the six possible landing points of the truck may be established by creating a file F11-F18 for each possible landing position and loading the file with a proportional part of the number set.

For example, if one truck position of Table I (e.g., “ON WHEELS”) has a 38% probability, then out of a set of 100 numbers, 38 of the 100 numbers may be entered into an associated file (e.g., F11 28). Similarly, a second file F12 30 may contain 14 numbers from the remaining 62 of the original 100 numbers, a third file F13 32 may contain 14 numbers of the remaining 48 numbers, a fourth file F14 34 may contain 11 numbers from the remaining 34 numbers, a fifth file F15 36 may contain 9 numbers from the remaining 23 numbers, a sixth file F16 38 may contain 7 numbers from the remaining 14 numbers, a seventh file F17 40 may contain 3 numbers of the remaining 7 numbers and an eighth file F18 42 may contain the remaining 4 numbers of the set.

The roll control 16 may be provided with a random number generator 50 that may be activated by a roll pushbutton 20. The random number generator 50 may be programmed to select any of the 100 numbers of the set under a random process. A comparator 48 compares the number selected by the random number generator 50 with the numbers stored in each of the files F11-F18 28, 30, 32, 34, 36, 38, 40, 42, 44 and selects the file (i.e., the die position) containing the matching number. Since the 100 numbers all have an equal probability of being selected, the random selection of any number of the 100 numbers in the set will result in the files F11-F18 28, 30, 32, 34, 36, 38, 40, 42, 44 being selected in a proportion that equals the portion shown in Option #2.

Once a file is selected, the associated image of the die in that position may be retrieved from the file and displayed on the display 18. An identifier (ID) of the die position (or a odds multiplier) may also be forwarded to the bet/payout control 14.

Within the bet/payout control 14, the odds multiplier may be multiplied by a payout ratio. For example, if the selected file is F11 28 and the proportion is 38%, then the odds multiplier is equal of one over 0.38 or 2.63. An associated payout ratio may be retrieved from a corresponding payout control file OF11 54. The retrieved payout ratio (e.g., 95%) may then be multiplied by the odds value (e.g., 2.63 in this example) and the product multiplied by the bet. The product of the odds multiplier, the payout ratio and the bet represents the payout to the player.

The encoded files F11-F1N 28, 30, 32, 34, 36, 38, 40, 42, 44 may be created within a programmers terminal 62 by a programmer working through a keyboard 66 and display 64. Using the keyboard 66, the programmer may enter a number of faces 68 on the die and the odds for landing on each face 70.

In response, a central processing unit (CPU) 74 may open the proportional files F11-F1N. In the case of Option #2 of Table I, the CPU 74 may open eight files F11-F18 28, 30, 32, 34, 36, 38, 40, 42. The CPU 74 may also function to save the proportional subset of numbers in each file. The subset may be continuous or generated using another random number generator 72.

Where the subset is continuous (and using the example of Option #2), the CPU 74 may store the numbers 1-38 in the first file F11 28. The numbers 39-52 may be stored in the second file F12 30, 53-66 in the third file F13 32, 67-77 in the fourth file F14 34, 78-86 in the fifth file F15 36, 87-93 in the sixth file F16 38, 94-96 in the seventh file F17 40 and 97-100 in the eight file F18 42.

Alternatively, the subsets may be generated by the random number generator in a further effort to randomize the dice roll. In this case, the CPU 74 accepts the first subset of 38 non-duplicated numbers between 1 and 100 from the random number generator 72 and places them in the first file F11 28. The next set of 14 numbers (not duplicated in the first and second files) is stored in the second file F12, 30 and so on.

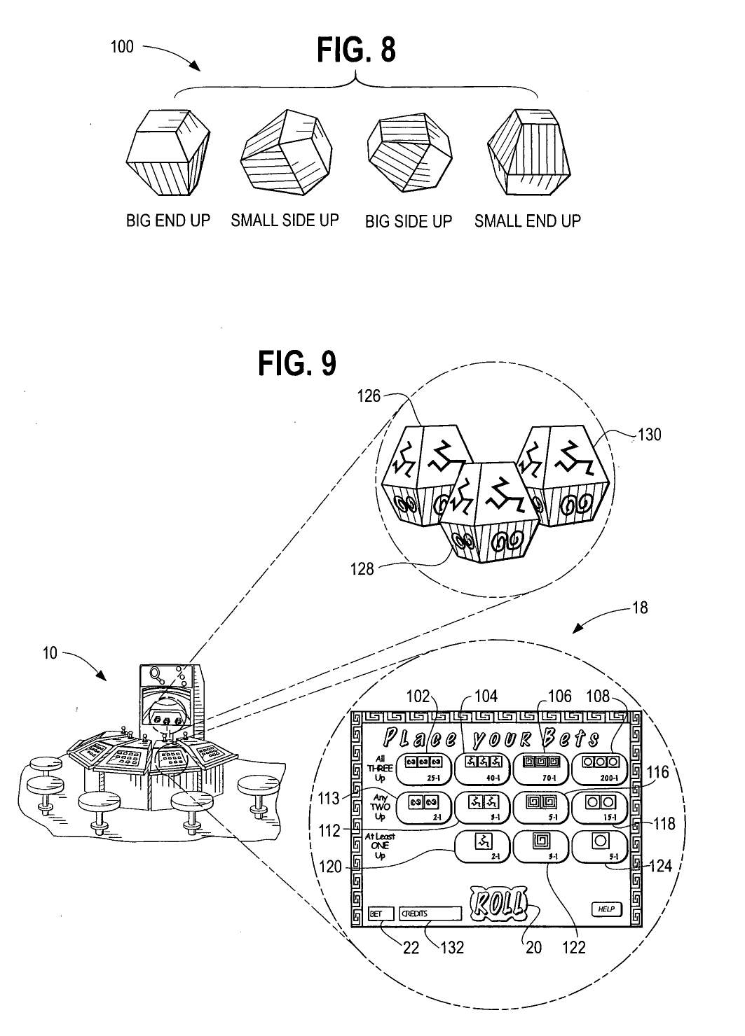

FIG. 8 depicts a 10-sided die 100 with four different sized faces. FIG. 9 depicts a video game 10 based upon three of the die 100 of FIG. 8 (now shown with identifying figures on each face).

It may be noted, that three identical die 126, 128, 130 are shown in the display 18 of FIG. 9. While three identical die 126, 128, 130 are shown in FIG. 9, it should be understood that the die do not need to be identical and may include any combination of die shown in FIGS. 2-8.

To set-up the game 10 shown in FIG. 9, the programmer may first program the odds for a first die 126. Since the first die has 10 faces, the programmer would create 10 files F11-F110. A different subset of numbers may be entered into each file F11-F110 to reflect the odds of landing on each face as described above. The process of setting up the files F21-F210 within a second memory space 76 for the second die 128 would be repeated using the same subsets of numbers (if the die are identical) or different subsets. The process of setting up the files F31-F310 within a third memory space 78 for the third die 130 would be repeated using the same subsets of numbers (if the die are identical) or different subsets.

Once the video game 10 has been programmed, it may be played by one or more players. Where a single player operates the video game 10 (FIG. 9), a set of betting options 102, 104, 106, 108, 110, 112, 114, 116, 118, 120, 124 may be provided offering a payout upon any of a number of different final positions of the dice 126, 128, 130 after each roll. Displayed on the softkey 102, 104, 106, 108, 110, 112, 114, 116, 118, 120, 124 associated with each option may be the combined display among the dice required to win as well as the payout for that betting option.

The player may enter a value amount (e.g., token, cash, credit, etc.) through the cash/credit processor 12. After the entry of each value amount, the player may select a different betting option 102, 104, 106, 108, 110, 112, 114, 116, 118, 120, 124. It should be noted in this regard that the player may select (and place) a number of different bets on the same roll of the dice 126, 128, 130. As the player enters the value amount for each bet, a credit display 132 shows the value amount. Once entering a value amount, the player may select an option 102, 104, 106, 108, 110, 112, 114, 116, 118, 120, 124 and activate the bet softkey 22. Once the player has entered as many options 102, 104, 106, 108, 110, 112, 114, 116, 118, 120, 124 as he desires, the player may activate the ROLL softkey 20.

Upon activating the ROLL softkey 20, the random number generator 50 may randomly generate three numbers. The first number may be compared within the comparator 48 with the set of numbers stored in the first set of files F11-F110, the second number may be compared with the set of numbers stored in the second set of files F21-F210 and the third number may be compared with the set of numbers stored in the third set of files F31-F310 to determine the respective die landing position. Once a final set of die positions are determined, the final positions of the die 126, 128, 130 may be shown on the display 18.

The comparator 48 may also compare the three die positions with the betting option selected and retrieve the odds multiplier shown in conjunction with the option. The player may choose to place another bet or accept payment of his winnings by pressing a credit softkey 132.

A specific embodiment of a method and apparatus for playing a video dice game according to the present invention has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of playing a video game of chance by a player using asymmetrical dice, such method comprising the steps of:
randomly determining a side on which an asymmetrical die will land based upon a predetermined landing odds for each side of the asymmetrical die in response to a request to roll the asymmetrical die;
displaying an image of the asymmetrical die lying on the randomly determined side; and
determining a payout to the player based upon a predetermined payout factor for the randomly determined side.

2. The method of playing the video game as in claim 1 further comprising providing a predetermined odds multiplier for each side of the asymmetrical die.

3. The method of playing the video game as in claim 1 further comprising providing a payout ratio for each side of the asymmetrical die.

4. The method of playing the video game as in claim 1 further comprising multiplying the odds multiplier by the payout ratio to determine the payout factor.

5. The method of playing the video game as in claim 1 further comprising calculating the predetermined landing odds for each side of the asymmetrical die by determining a ratio between a surface area of each side and a total surface area of the die.

6. The method of playing the video game as in claim 5 wherein the step of calculating the predetermined landing odds for each side of the asymmetrical die further comprises adjusting the determined landing odds by an adjustment factor.

7. The method of playing the video game as in claim 1 wherein the step of determining the payout further comprises multiplying the predetermined payout factor for the randomly determined side by a bet placed by the player.

8. The method of playing the video game as in claim 1 further comprising making the payout to the player.

9. The method of playing the video game as in claim 1 further comprising calculating the predetermined payout factor for the randomly determined side by determining an area ratio between a surface area of the randomly determined side and a total surface area of the die.

10. The method of playing the video game as in claim 9 wherein the step of calculating the predetermined payout factor further comprises adjusting the area ratio by a payout ratio.

11. The method of playing the video game as in claim 1 further comprising detecting placement of a bet by the player.

12. The method of playing the video game as in claim 1 further comprising randomly determining a side on which an at least one other asymmetrical die will land based upon a predetermined landing odds ratio for each side of the at least one other asymmetrical die in response to the request to roll.

13. The method of playing the video game as in claim 12 further comprising displaying an image of the asymmetrical die and the at least one other asymmetrical die lying on their randomly determined sides.

14. The method of playing the video game as in claim 13 further comprising determining a payout to the player based upon a predetermined payout ratio for the randomly determined sides.

15. The method of playing the video game as in claim 1 wherein the step of randomly determining a side on which the asymmetrical die will land further comprises randomly selecting a number from a plurality of odds selection files.

16. The method of playing the video game as in claim 1 further comprising encoding each odds selection file of the plurality of odds selection files with the predetermined landing odds for a respective side of the asymmetrical die.

17. An apparatus for playing a video game of chance by a player using an asymmetrical die, such apparatus comprising:
means for randomly determining a side on which the asymmetrical die will land based upon a predetermined landing odds for each side of the asymmetrical die in response to a request to roll the asymmetrical die;
means for displaying an image of the asymmetrical die lying on the randomly determined side; and
means for determining a payout to the player based upon a predetermined payout factor for the randomly determined side.

18. The apparatus for playing the video game as in claim 17 further comprising means for providing a predetermined odds multiplier for each side of the asymmetrical die.

19. The apparatus for playing the video game as in claim 17 further comprising means for providing a payout ratio for each side of the asymmetrical die.

20. The apparatus for playing the video game as in claim 17 further comprising means for multiplying the odds multiplier by the payout ratio to determine the payout factor.

21. The apparatus for playing the video game as in claim 17 further comprising means for calculating the predetermined landing odds for each side of the asymmetrical die by determining a ratio between a surface area of each side and a total surface area of the die.

22. The apparatus for playing the video game as in claim 21 wherein the means for calculating the predetermined landing odds for each side of the asymmetrical die further comprises means for adjusting the determined landing odds by an adjustment factor.

23. The apparatus for playing the video game as in claim 17 wherein the means for determining the payout further comprises means for multiplying the predetermined payout factor for the randomly determined side by a bet placed by the player.

24. The apparatus for playing the video game as in claim 17 further comprising means for making the payout to the player.

25. The apparatus for playing the video game as in claim 17 further comprising means for calculating the predetermined payout factor for the randomly determined side by determining an area ratio between a surface area of the randomly determined side and a total surface area of the die.

26. The apparatus for playing the video game as in claim 25 wherein the means for calculating the predetermined payout factor further comprises adjusting the area ratio by a payout ratio.

27. The apparatus for playing the video game as in claim 17 further comprising means for detecting placement of a bet by the player.

28. The apparatus for playing the video game as in claim 17 further comprising means for randomly determining a side on which an at least one other asymmetrical die will land based upon a predetermined landing odds ratio for each side of the at least one other asymmetrical die in response to the request to roll.

29. The apparatus for playing the video game as in claim 28 further comprising means for displaying an image of the asymmetrical die and the at least one other asymmetrical die lying on their randomly determined sides.

30. The apparatus for playing the video game as in claim 29 further comprising means for determining a payout to the player based upon a predetermined payout ratio for the randomly determined sides.

31. An apparatus for playing a video game of chance by a player using an asymmetrical die, such apparatus comprising:
a random number generator randomly determining a side on which the asymmetrical die will land based upon a predetermined landing odds for each side of the asymmetrical die in response to a request to roll the asymmetrical die
a display that displays an image of the asymmetrical die lying on the randomly determined side; and
a payout controller adapted to determine a payout to the player based upon a predetermined payout factor for the randomly determined side.

32. The apparatus for playing the video game as in claim 31 further comprising an odds selection file adapted to provide a predetermined odds multiplier for each side of the asymmetrical die.

33. The apparatus for playing the video game as in claim 32 further comprising a payout control file adapted to provide a payout ratio for each side of the asymmetrical die.

34. The apparatus for playing the video game as in claim 31 further comprising a multiplier adapted to multiply the odds multiplier by the payout ratio to determine the payout factor.

35. The apparatus for playing the video game as in claim 31 further comprising a cash/credit processor adapted to make the payout to the player.

36. The apparatus for playing the video game as in claim 31 further comprising a programmers terminal adapted to generate the odds selection files.

37. The apparatus for playing the video game as in claim 31 further comprising a comparator adapted to determine the randomly determined side by comparing a number generated by the random number generator with a set of numbers within the plurality of odds selection files.

38. The apparatus for playing the video game as in claim 31 further comprising a random number generatorcash/credit processor adapted to make the payout to the player.
